(19) United States
(12) Patent Application Publication
(10) Pub. No.: US 2024/0384146 A1
(43) Pub. Date: Nov. 21, 2024

(54) HEAT DISSIPATING LAMINATE

(71) Applicant: JAPAN MATEX CO., LTD., Osaka (JP)

(72) Inventors: Katsuro TSUKAMOTO, Osaka (JP); Hiroaki TSUKAMOTO, Osaka (JP)

(21) Appl. No.: 18/198,789

(22) Filed: May 17, 2023

(51) Int. Cl. C09K 5/14; B32B 5/18; B32B 9/04; C04B 35/536; C04B 37/02

(52) U.S. Cl. CPC C09K 5/14; B32B 5/18; B32B 9/041; B32B 9/045; C04B 35/536; C04B 37/028; B32B 2266/04; B32B 2307/72; C04B 2235/3826; C04B 2235/425; C04B 2235/9607; C04B 2237/363; C04B 2237/402

(57) ABSTRACT

Provided herein is a heat dissipating laminate that exhibits excellent heat conductivity not only in the plane direction (XY-axis direction), but also in the thickness direction (Z-axis direction). The heat dissipating laminate of the present invention is characterized in comprising: a first layer consisting of one or more selected from the group consisting of expanded graphite and mixed graphite; a first sheet body laminated to one surface of the first layer; and a second sheet body laminated to another surface of the first layer, wherein a coating is applied on the second sheet body.

### BACKGROUND OF THE INVENTION

### Field of the Invention

The present invention relates to a heat dissipating laminate. More specifically, it relates to a heat dissipating laminate having a laminate structure and a coating applied to the surface of the laminate.

### Description of the Related Art

Conventionally, heat dissipating sheets with expanded graphite sheets have been used as heat dissipating materials for electronic products such as personal computers, smartphones and the like (see, for example, Japanese Unexamined Patent Application Publication No. 2015-46557), and the document describes a heat dissipating material in which a laminate having a structure in which an expanded graphite sheet is sandwiched between metal foils from both surfaces is bent into a corrugate shape (see, for example, Japanese Patent No. 3649150), and Japanese Patent No. 3649150 describes a heat dissipating material in which an artificial graphite sheet, made from polymer film that has been graphitized to exhibit thermal conductivity, is attached to a metal plate and then bent into a wave-shape together with the metal plate.

Further, a graphite sheet obtained by carbonizing a polyamide film to obtain a carbonaceous film and then heat-treating (graphitizing) the carbonaceous film is also known to be used as a heat dissipating material (see, for example, International Publication WO2019/187620).

Furthermore, in Japanese Patent No. 6465368, the applicant proposes a heat dissipating material in which one or more thermally conductive fillers selected from the group consisting of artificial graphite, boron nitride and milled pitch-based carbon fibers are uniformly mixed to obtain two types of graphite foam with different particle sizes to increase the thermal conductivity in the thickness direction and further sandwiched between sheet bodies to increase the thermal conductivity in the plane direction.

### BRIEF SUMMARY OF THE INVENTION

### Problem to be Solved by the Invention

A heat radiator with a conventional expanded graphite sheet as described in Japanese Unexamined Patent Application Publication No. 2015-46557 and Japanese Patent No. 3649150 has excellent thermal conductivity in the plane direction (XY-axis direction), but has the problem of having low thermal conductivity in the thickness direction (Z-axis direction).

On the other hand, a graphite sheet obtained by carbonizing a polyimide film to obtain a carbonaceous film and then heat-treating (graphitizing) the carbonaceous film is used as a heat dissipating material (see, for example, International Publication WO2019/187620), which has excellent thermal conductivity in the thickness direction (Z-axis direction), but has the problem of having low thermal conductivity in the plane direction (XY-axis direction).

Further, the heat dissipating material in Japanese Patent No. 6465368 is a heat dissipating material proposed with a thermal conductivity of 3-10 W/m·K in the thickness direction and 50-250 W/m·K in the plane direction, which is not necessarily sufficient, although a certain conductivity in the thickness direction (Z-axis direction) is achieved.

The present invention aims to solve the above-mentioned problem, i.e., providing a heat dissipating laminate that exhibits excellent heat conductivity not only in the plane direction (XY-axis direction), but also in the thickness direction (Z-axis direction).

### Means for Solving the Problem

The invention according to a first aspect relates to a heat dissipating laminate comprising:
a first layer consisting of one or more selected from the group consisting of expanded graphite and mixed graphite,
a first sheet body laminated to one surface of the first layer; and
a second sheet body laminated to another surface of the first layer, wherein a coating is applied on the second sheet body.

The invention according to a second aspect relates to the heat dissipating laminate of the first aspect,
wherein the first layer is a mixed graphite layer, the mixed graphite layer comprising graphite foam and a filler, and
the first sheet body is a polyester sheet or aluminum foil.

The invention according to a third aspect relates the heat dissipating laminate of the first aspect,
wherein the graphite foam consists of a first graphite foam with a smaller particle size and a second graphite foam with a larger particle size.

The invention according to a fourth aspect relates to the heat dissipating laminate of the second aspect,
wherein the filler is one or more thermally conductive fillers selected from the group consisting of artificial graphite, boron nitride and milled pitch-based carbon fibers,
the graphite foam has the first graphite foam of 30-45 weight percent and the second graphite foam of 50-65 weight percent,
the graphite foam constitutes 80-95 weight percent of the whole mixed graphite layer, and
the mixed graphite layer has a density of 0.8-1.5 g/cm³.

The invention according to a fifth aspect relates to the heat dissipating laminate of the first aspect,
wherein the first layer is a mixed graphite layer or expanded graphite layer, and
a graphite film is laminated to a lower surface of the first sheet body via an adhesive layer.

The invention according to a sixth aspect relates to the heat dissipating laminate of the first to fourth aspects,
wherein the coating layer comprises a composition containing a polyimide component, a fluororesin component, fine particles of polar crystals, and water.

The invention according to a seventh aspect relates to the invention of the fifth aspect,
wherein the fine particles of polar crystals are one or more fine particles selected from the group consisting of pink tourmaline and black tourmaline.

The invention according to an eighth aspect relates to the heat dissipating laminate according to the first or second aspect,
wherein the adhesive layer consists of one or more metal oxide sols selected from the group consisting of metal oxide sols of tin oxide, titanium oxide, tantalum oxide, niobium oxide and zirconium oxide; one or more compounds selected from the group consisting of potassium persulphate, acetic acid, benzoic acid, phenyl phosphonic acid and benzoyl; and PVA resin.

### Effect of the Invention

In accordance with the invention according to the first aspect, this invention is characterized in comprising:
a first layer consisting of one or more selected from the group consisting of expanded graphite and mixed graphite;
a first sheet body laminated to one surface of the first layer; and
a second sheet body laminated to another surface of the first layer, wherein a coating is applied on the second sheet body,
   and thus, can provide a heat dissipating laminate that exhibits excellent heat conductivity not only in the plane direction (XY-axis direction), but also in the thickness direction (Z-axis direction).

In accordance with the invention according to the second aspect, this invention is characterized in that:
the first layer is a mixed graphite layer, the mixed graphite layer comprising graphite foam and a filler, and
the first sheet body is a polyester sheet or aluminum foil,
   and thus, can provide a heat dissipating laminate that exhibits excellent heat conductivity not only in the plane direction (XY-axis direction), but also in the thickness direction (Z-axis direction).

In accordance with the invention of the third aspect, this invention has a configuration in which:
the graphite foam consists of a first graphite foam with a smaller particle size and a second graphite foam with a larger particle size,
and thus, can increase the weight percentage of the graphite foam in the whole mixed graphite, thereby further enhancing the thermal conductivity in the thickness direction.

In accordance with the invention according to the fourth aspect, this invention has a configuration in which:
the filler is one or more thermally conductive fillers selected from the group consisting of artificial graphite, boron nitride and milled pitch-based carbon fibers,
the graphite foam has the first graphite foam of 30 to 45 wt. % and the second graphite foam of 50 to 65 wt. %,
the graphite foam constitutes 80 to 95 wt. % of the whole mixed graphite layer, and
the mixed graphite layer has a density 0.8 to 1.5 g/cm³,
   and thus, can achieve thermal conductivity above that of the heat dissipating material disclosed in the above Japanese Patent No. 6465368.

In accordance with the invention according to the fifth aspect, this invention has a configuration in which:
the first layer is a mixed graphite layer or expanded graphite layer, and
a graphite film is laminated to the lower surface of the first sheet body via an adhesive layer,
   and thus, can provide a heat dissipating laminate that exhibits excellent thermal conductivity not only in the plane direction (XY-axis direction), but also in the thickness direction (Z-axis direction).

In accordance with the invention according to the sixth aspect, this invention has a configuration in which:
the coating layer comprises a composition containing a polyimide component, a fluororesin component, fine particles of polar crystals, and water,
   and thus, can further enhance the thermal conductivity in the thickness direction.

In accordance with the invention according to the seventh aspect, this invention has a configuration in which:
the fine particles of polar crystals are one or more fine particles selected from the group consisting of pink tourmaline and black tourmaline,
   and thus, can further enhance the thermal conductivity in the thickness direction.

In accordance with the invention according to the eighth aspect, this invention has a configuration in which:
the adhesive layer consists of one or more metal oxide sols selected from the group consisting of metal oxide sols of tin oxide, titanium oxide, tantalum oxide, niobium oxide and zirconium oxide; one or more compounds selected from the group consisting of potassium persulphate, acetic acid, benzoic acid, phenyl phosphonic acid and benzoyl; and PVA resin,
   and thus, can strongly bond and join the first and second layers.

In the present invention, mixed graphite refers to a uniform mixture of two types of graphite foam with different particle sizes and a filler.

The mixed graphite of the present invention is the one which introduces a filler between the particles of graphite foam to improve the thermal conductivity in the thickness direction (Z-axis direction) which is low in a conventional expanded graphite sheet; has graphite foam and a filler mixed so that the graphite foam becomes a bridge between molecules of the filler; and can be extended into a sheet.

The plane direction refers to a direction parallel to the surface of the sheet, and the thickness direction refers to a direction perpendicular to the surface of the sheet.

Graphite foam refers to a material which is formed by pulverizing natural graphite into particles, subsequently immersing the particles in sulfuric acid, neutralizing and cleaning them, and also heat foaming them at high temperature.

When the present graphite foam is composed of two types of graphite foam with different particle sizes, i.e., a first graphite foam with a particle size of 30 to 50 μm and a second graphite foam with a particle size of 200 to 250 μm, it has improved thermal conductivity in the thickness direction compared to that of a mixture of graphite foam with the same particle size and a filler.

When the graphite foam is composed of these two types of graphite foam with different sizes, the proportion of the first and second graphite foams in the present graphite foam are 30 to 45 wt. %, and 50 to 65 wt. %, respectively.

Heat foaming at high temperature is performed, for example, by heating at high temperature with air blocked, in which the high temperature may be between 1000° C. and 2000° C. To treat natural graphite at high temperature, it is desirable to use a furnace such as a graphitization furnace.

The filler of the present invention refers to a filling material with high thermal conductivity. The filler includes, but is not limited to, hexagonal boron nitride and carbon compounds, for example, milled pitch-based carbon fibers, boron nitride, and artificial graphite.

The artificial graphite of the present invention includes those having coke and pitch as raw materials, or those graphitized by heating and sintering polyimide films in inert gas.

The mixed graphite of the present invention is manufactured, for example, by mixing a filler with graphite foam which is made by processing natural graphite as described above. Alternatively, it may be manufactured by mixing a filler with acid-treated graphite powder which is made by pulverizing natural graphite into particles, and subsequently immersing the particles in sulfuric acid, neutralizing and cleaning them, and heat foaming them at high temperature. When artificial graphite is used for the filler, the artificial graphite does not foam even if the filler is mixed with acid-treated graphite powder and heat foamed at high temperature.

The method for mixing the graphite foam and the filler, and the method for mixing the acid-treated graphite powder and the filler include, but are not limited to, a method of mixing by rotating with an agitator.

The preferred mixing ratio of the graphite foam to the filler is 8:2

In addition, the density of the mixed graphite is 0.8-1.65 g/cm³, particularly suitably 1.50 g/cm³.

Since the graphite foam itself has low strength and there is a risk of graphite powder scattering inside the equipment to be used, causing electrical disturbances, an improvement is made to this aspect by sandwiching a graphite layer between the first and second sheet bodies. Polyethylene terephthalate (PET) or other resin sheets may be used as these first and second sheet bodies, and metal foils, preferably aluminum foils, may also be used. The thickness of the sheet bodies is preferably 0.25 to 1.65 mm.

When sandwiching the mixed graphite between the first and second sheet bodies, one of these two sheet bodies may be laid in advance, and then the mixed graphite may be extended over it and the other sheet body may be attached, or the mixed graphite may be rolled with rollers together with the sheet bodies to which an adhesive is applied, or the mixed graphite rolled in advance with rollers or the like may be sandwiched between these two sheet bodies as a manufacturing method.

### BRIEF DESCRIPTION OF THE DRAWINGS

FIG. 1 is a cross-sectional illustration of a heat dissipating laminate according to one embodiment of the present invention.

FIG. 2 is a cross-sectional illustration of a heat dissipating laminate according to another embodiment of the present invention.

### DETAILED DESCRIPTION OF THE INVENTION

### Embodiment 1

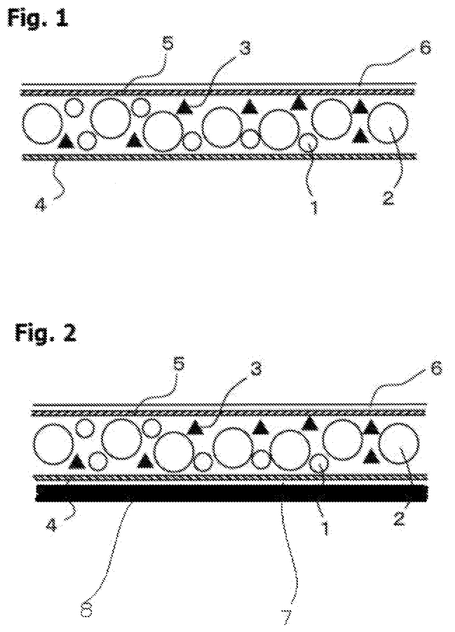

Referring to FIG. 1, a manufacturing method of a heat dissipating laminate according to Embodiment 1 of the present invention is described.

First, 40 wt. % of a first graphite foam (1) with a particle size of 30 to 50 μm and 60 wt. % of a second graphite foam (2) with a particle size of 200 to 250 μm were combined with a filler (3) of green silicon carbide (hereinafter referred to as “artificial graphite”).

The combination ratio between the first and second graphite foams (1, 2) and artificial graphite filler (3) was 80 wt. % to 20 wt. %, respectively, so that a mixed graphite was obtained.

The first sheet body (4) and the second sheet body (5) made of 0.02 mm aluminum foils, which had been previously treated with an adhesive, were placed, the formed mixed graphite (1, 2, 3) was put on top, and the first sheet body (4) and the second sheet body (5) were laminated and press-molded, which produced a laminate with a thickness of 0.5 mm.

Then, a coating (6) was applied to the second sheet body (5) of aluminum foil to obtain a heat dissipating laminate.

From the above, the heat dissipating laminate of this embodiment comprises a first layer (1, 2, 3) consisting of mixed graphite (1, 2, 3); a first sheet body (4) laminated to the bottom surface that is one surface of the first layer (1, 2, 3); a second sheet body (5) laminated to the top surface that is another surface of the first layer (1, 2, 3), wherein a coating is applied on the second sheet body (5). And, this configuration can provide a heat dissipating laminate that exhibits excellent heat conductivity not only in the plane direction (XY-axis direction), but also in the thickness direction (Z-axis direction).

The first layer (1, 2, 3) (mixed graphite layer) can include graphite foam (1, 2) and a filler (3), and the first sheet body (4) can be a polyester sheet or aluminum foil.

When the graphite foam comprises a first graphite foam (1) with a smaller particle size and a second graphite foam (2) with a larger particle size, the wt. % of the graphite foam in the whole mixed graphite layer (1, 2, 3) can be increased, which can further enhance the thermal conductivity in the thickness direction.

The filler (3) may be one or more thermally conductive fillers selected from the group consisting of artificial graphite, boron nitride, and milled pitch-based carbon fibers; the graphite foam (1, 2) may have the first graphite foam (1) of 30 to 45 wt. % and the second graphite foam (2) of 50 to 65 wt. %; the graphite foam (1, 2) constitutes 80 to 95 wt. % of the whole mixed graphite layer (1, 2, 3); and the mixed graphite layer (1, 2, 3) has a density of 0.8 to 1.5 g/cm³.

In this embodiment, an expanded graphite layer may be employed in place of the mixed graphite layer. In this embodiment, expanded graphite refers to caterpillar-shaped graphite powder in which graphite intercalation compound comprising graphite oxide is rapidly thermally decomposed at high temperature, and the gasification pressure of the products resulting from the decomposition causes the graphite intercalation to expand perpendicular to the hexagonal plane. Then, in the present invention, an expanded graphite layer refers to an expanded graphite layer formed by supplying expanded graphite from a hopper to a precompression roll with a vibrating belt, preforming, and then roll forming after heat treatment for deaeration and purification.

It is preferable to use an adhesive containing a polyimide precursor or polyimide, fluororesin, fine particles of polar crystals, and water as the coating (6), as described in Japanese Patent No. 6781442 owned by the applicant.

Polyimide is a resin consisting of a polymer having imide bonds in its molecular structure, and can be synthesized, for example, by the general synthesis method shown in the formula below. In this synthesis method, tetracarboxylic dianhydride and diamine are polymerized in equimolar quantities to the raw materials to obtain polyamide acid, a polyimide precursor.

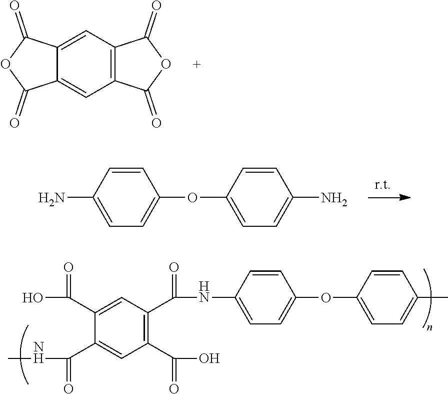

This polyamide acid is heated to 200° C. or higher, or proceeded with dehydration and cyclization (imidization) reactions with catalysts to obtain polyimide. When catalysts are used, amine-based compounds are often used, and carboxylic anhydride can be used in combination as a dehydrating agent to quickly remove water generated by imidization.

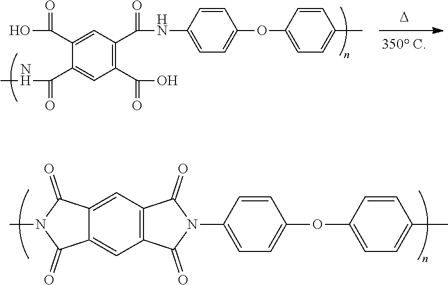

In the present invention, a polyimide precursor refers to a compound that may be a raw material for polyimide, preferably polyamide acid, polyamideimide, polyamic acid, or a mixture thereof. In addition, a polyimide precursor may include substances described in Japanese Patent No. 5695675 or Japanese Patent No. 6186171. An example of a polyimide precursor is shown below.

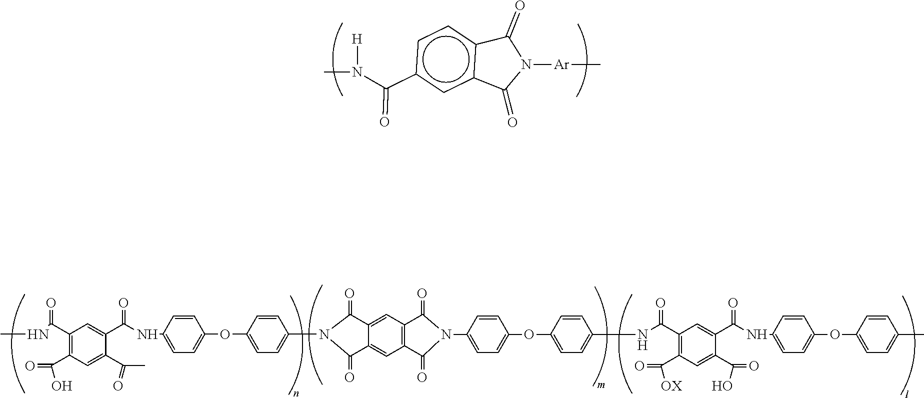

(In the formula, symbol X is an alkali metal (lithium/Li, sodium/Na, potassium/K, rubidium/Rb, or cesium/Ce), the subscripts n and I are symbols indicating the amount (in moles) of polyamide acid structure present on both sides of the polyimide structure, of which the value is usually in the range of 0.1 to 0.8, and the subscript m is a symbol indicating the amount (in moles) of polyimide structure present, of which the value is usually in the range of 0.2 to 0.9.)

The polyimide used in the mixed aqueous dispersion is not particularly limited and includes, for example, resins consisting of high molecular weight polymers obtained by the reaction of aromatic tetravalent carboxylic anhydrides such as pyromellitic anhydride, and any other resin that is obvious to a person skilled in the art can be used. The polyimide used in the mixed aqueous dispersion may be recycled from used polyimide that has been pulverized, or may be unused.

The form of polyimide is not particularly limited, but in view of the ease of maintaining a suspended dispersion state in a mixed aqueous dispersion for a long period of time, the particle size of the fine particles is desirably in the range of 1 μm to 100 μm.

The content of polyimide is desirably from 5 to 40 wt. %, and more desirably from 10 to 30 wt. %, and from 10 to 20 wt. % with respect to the mixed aqueous dispersion.

The mixed aqueous dispersion of this invention preferably contains polyamide acid, which is a polyimide precursor. Polyamide acid can be dehydrated and cyclized (imidized) by heating at 200° C. or higher. This process of imidization can allow the mixed aqueous dispersion containing polyamide acid form a stronger coating.

The mixed aqueous dispersion of the present invention may comprise one or more polyimide analogues selected from polyamic acid, polyamidimide, polyamic acid, or polyamide ester as precursors of polyimide. These polyimide analogues are essential components for providing the adhesive property of the mixed aqueous dispersion with a positive effect and preparing a coating film with high heat resistance and high strength. Preferably, the mixed aqueous dispersion of the present invention includes polyimide dispersions containing polyamic acid.

Herein, the term polyimide is to be understood as polyimide in the broadest sense encompassing polyimide precursors and polyimide analogues in addition to polyimide contained in the mixed aqueous dispersion.

Formulations comprising polyimide as raw material that are suitably employed in the present invention include, but are not limited to, W-20, manufactured by Nakada Coating KK.

Such formulations may include phosphoric acid, ethanol dispersion, amines, propylene glycol, nonionic components (neutral additives), carbon black as a coloring component, and the like.

In the present invention, polar crystals are crystals with a positive charge (+) on one side and a negative charge (−) on the opposite side.

Polar crystals always produce unstable condition (potential difference), and because of this potential difference, electrons are constantly released and flow from the negative charge towards the positive charge.

Herein, the fine particles of polar crystals are one or more selected from the group consisting of pink tourmaline, black tourmaline, and hexahedrite (registered trademark), but are not limited thereto.

Among polar crystals, tourmaline is particularly well known.

Tourmaline is a crystalline material with the chemical formula XY₃Al₆(BO₃)₃SiO₁₈(O,OH,F)₄, including dravite NaMg₃Al₆(BO₃)₃Si₆O₁₈(OH)₄, elbaite Na(Li,Al)₃Al₆(BO₃)₃Si₆O₁₈(OH)₄, schorl NaFe₃Al₆(BO₃)₃Si₆O₁₈(OH)₄, and uvite CaMg₃(Al₅Mg)(BO₃)₃Si₆O₁₈(OH,F)₄.

Tourmaline is said to have been discovered in the island of Ceylon, current Sri Lanka in 1703 and traversed to Europe. Later, in 1880, Pierre Curie, who received the Nobel Prize in Physics, discovered that when external pressure is applied to tourmaline crystals, an electric charge is formed on the crystal surface. Moreover, it was found that an electric charge is also formed when thermal energy is applied to tourmaline. The phenomenon that occurs when pressure is applied to tourmaline is called piezoelectricity, and the phenomenon in which electrons are separated into the two poles of the crystal when heat is applied, producing positive and negative electricity is called pyroelectricity. When pressure or heat is applied to tourmaline, positive and negative charges are formed on both poles of the stone, generating electricity. The positive pole attracts electrons and emits electrons from the negative pole to the outside of the crystal (in water, on the body's skin surface, or anywhere else where electricity flows easily). This generated water and moisture in the air is electrolyzed to release negative ions called hydroxyl ions (H₃O²⁻).

According to the present invention, coatings and paints with outstanding coating properties can be obtained by using polar crystals, and this is presumably due to, but not limited to, the electrical properties of tourmaline as described above. The polar crystals of the present invention can be used as aqueous dispersion by pulverizing mineral of the polar crystals into fine particles (for example, the particle size is 10 μm or less, 5 μm or less, 5 μm or less, or 1 μm or less). Aqueous dispersion of polar crystals are, for example, suspensions with a concentration of 5 to 40 wt. %.

The fluororesins used in the mixed aqueous dispersion are not particularly limited, and include, for example, resin fine particles consisting of polymer or copolymer of monomers selected from tetrafluoroethylene, hexafluoropropylene, chlorotrifluoroethylene, perfluoro (alkyl vinyl ether), vinylidenfluoride, and vinylfluoride.

Of these, those that disperse in water are used in the preparation of a mixed aqueous dispersion. The form of the fluororesin is not particularly limited, but in view of the ease of maintaining a suspended dispersion state in a mixed aqueous dispersion for a long period of time, the fine particles are desirably in the range of 1×10⁴ to 1×10⁷ in average molecular weight, and 100 to 500 nm in particle size. The fluororesin content (fluororesin solid content) is desirably from 20 to 60 wt. %, and more desirably from 35 to 45 wt. % with respect to the mixed aqueous dispersion.

For the fluororesin used in the mixed aqueous dispersion, as described above, for example, A-1: Daikin Industries, Ltd., Polyflon D-111 (PTFE solid content: 55-65 wt. %, average molecular weight: 2×10⁴ to 1×10⁷, particle size: 0.25 μm, pH: 9.7), A-2: Asahi Glass, AD911E (PTFE solid content: 60 wt. %, average molecular weight: 2×10^{4 to} 1×10⁷, particle size: 0.25 μm, pH: 10), A-3: Mitsui Fluoro, 31-JR (PTFE solid content: 60 wt. %, average molecular weight: 2×10⁴ to 1×10⁷, particle size: 0.25 μm, pH: 10.5) or the like can be used, but are not particularly limited. The particle size refers to the average particle diameter of the PTFE primary particles.

The fluororesin used in the mixed aqueous dispersion may be a PTFE dispersion, which may comprise neutral surfactants, nonionic surfactants, amines, glycols, and the like. PTFE-D (manufactured by Daikin Industries, Ltd.) or the like is preferably used as such PTFE dispersion.

The mixed aqueous dispersion contains alumina. In the present invention, alumina encompasses aluminum oxide fine particles of: aluminum oxide [composition formula: Al₂O₃], amorphous aluminum hydroxide, gibbsite, bialite [composition formula: Al(OH)₃] and/or boehmite or diaspore [composition formula: AlOOH]. In view of the ease of maintaining a suspended dispersion state in a mixed aqueous dispersion for a long period of time, the particle size of the fine particles of alumina is desirably in the range of 5 to 4500 nm.

The content of alumina desirably ranges from 1 wt. % to 10 wt. %, and more desirably from 3 wt. % to 7 wt. % with respect to the mixed aqueous dispersion. This is because when the content of alumina is less than 1 wt. %, the adhesive properties and heat resistance properties originating from alumina cannot be sufficiently imparted to the mixed aqueous dispersion, and even when the content exceeds 10 wt. %, no further effects can be expected. By including alumina in the mixed aqueous dispersion, it is possible to make a mixed aqueous dispersion with excellent adhesive properties and heat resistance properties.

The form of alumina in alumina sol is not particularly limited and may be any shape, such as plate, columnar, fibrous, hexagonal plate, etc. In the case that alumina sol is alumina fiber, alumina fiber is fibrous crystals of alumina. More specifically, these include alumina fibers formed of alumina anhydrate, alumina hydrate fibers formed of alumina with hydrate, etc.

The alumina used in the mixed aqueous dispersion is not particularly limited, but include, for example, Alumina sol-10A (Al₂O₃ equivalent wt. %: 9.8-10.2, particle size nm: 5-15, viscosity 25° C., mPa/s: <50, pH: 3.4-4.2, manufactured by Kawaken Fine Chemicals Co., Ltd.), Alumina sol-A2 (Al₂O₃ equivalent wt. %: 9.8-10.2, particle size nm: 10-20, viscosity 25° C., mPa/s: <200, pH: 3.4-4.2, manufactured by Kawaken Fine Chemicals Co., Ltd.), Alumina sol-CSA-110AD (Al₂O₃ equivalent wt. %: 6.0-6.4, particle size nm: 5-15, viscosity 25° C., mPa/s: <50, pH: 3.8-4.5, manufactured by Kawaken Fine Chemicals Co., Ltd.), Alumina sol-F1000 (Al2O3 equivalent wt. %: 4.8-5.2, particle size nm: 1400, viscosity 25° C., mPa/s: <1000, pH: 2.9-3.3, manufactured by Kawaken Fine Chemicals Co., Ltd.), and Alumina sol- F3000 (Al₂O₃ equivalent wt. %: 4.8-5.2,particle size nm: 2000-4500, viscosity 25° C., mPa/s: <−1000, pH: 2.7-3.3, manufactured by Kawaken Fine Chemicals Co., Ltd.) etc., and any alumina sol that is obvious to a person skilled in the art can be used.

Alumina used in the mixed aqueous dispersion is, as described above, particularly not limited, but it is desirable to use alumina fine particles with hydroxyl groups (OH groups). The use of alumina with OH groups increases the chemical bonding strength (adhesion) due to the OH groups of the alumina, thus providing the mixed aqueous dispersion with better adhesive properties.

Other metal oxide fine particles may be added in place of or in addition to alumina. Other metal oxide fine particles can be, but are not particularly limited to: titanium oxide, zirconium oxide, lanthanum oxide, neodymium oxide, cerium oxide, or tin oxide etc. By adding these metal oxide fine particles instead of or in addition to alumina, a mixed aqueous dispersion of polyimide-fluororesin-polar crystal fine particles with different coating properties than when alumina alone is added can be produced.

The mixed aqueous dispersion contains potassium persulfate. Since potassium persulfate is a compound containing OH groups, the number of OH groups included in the mixed aqueous dispersion can be increased, which increases the chemical bonding strength (adhesion) by OH groups, giving the mixed aqueous dispersion excellent adhesive properties. The content of potassium persulfate is desirably 0.1 wt. % to 5 wt. %, and more desirably 1 wt. % to 3 wt. % with respect to the mixed aqueous dispersion. This is because when the content of potassium persulfate is less than 0.1 wt. %, the adhesive properties originating from potassium persulfate cannot be sufficiently imparted to the mixed aqueous dispersion, and even when the content exceeds 5 wt. %, no further effect can be expected.

Other compounds containing OH groups may be added instead of or in addition to potassium persulfate. As other OH group-containing compounds, acetic acid, benzoic acid, phenylphosphonic acid, or benzoyl compounds can be used, but are not particularly limited.

The mixed aqueous dispersion may further contain PVA (polyvinyl alcohol). PVA has the structural formula shown below and contains a number of OH groups. Therefore, the number of OH groups included in the mixed aqueous dispersion can be increased, which increases the chemical bonding strength (adhesion) by the OH groups, giving the mixed aqueous dispersion excellent adhesive properties.

PVA remains stable in the mixed aqueous dispersion even after being blended into the mixed aqueous dispersion, and there is little risk of degradation of its adhesive properties. Therefore, the excellent adhesive properties of the mixed aqueous dispersion can be maintained stably over a long period of time.

The content of PVA is desirably 0.5 wt. % to 10 wt. %, and more desirably 3 wt. % to 6 wt. % with respect to the mixed aqueous dispersion. This is because when the content of PVA is less than 0.5 wt. %, the adhesive properties originating from PVA cannot be sufficiently imparted to the mixed aqueous dispersion, and even when the content exceeds 10 wt. %, no further effect can be expected.

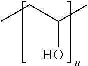

The mixed aqueous dispersion may further contain phosphoric acid. Since phosphoric acid is a compound containing OH groups, the number of OH groups included in the mixed aqueous dispersion can be increased, which increases the chemical bonding strength (adhesion) by the OH groups, giving the mixed aqueous dispersion solution excellent adhesive properties.

The content of phosphoric acid is desirably 0.1 wt. % to 5 wt. %, and more desirably 1 wt. % to 3 wt. %. This is because when the content of phosphoric acid is less than 0.1 wt. %, the adhesive properties originating from phosphoric acid cannot be sufficiently imparted to the mixed aqueous dispersion solution, and even when the content exceeds 5 wt. %, no further effect can be expected.

Phosphoric acid may be used for pre-treatment of the polyimide used in the mixed aqueous dispersion. Polyimide is added to ethanol phosphate containing phosphoric acid, mixed, and then ethanol is evaporated to obtain a polyimide-phosphoric acid mixed powder. Polyimide-phosphoric acid mixed powder can be dispersed more readily in an aqueous solvent than polyimide alone.

Apart from the above components, the mixed aqueous dispersion may contain other additives etc. to modify the mixed aqueous dispersion. Examples of additives include, but are not limited to, solvents, adhesive agents, plasticizers, curing agents, and cross-linking agents, diluents, fillers, thickeners, pigments, etc. As long as the additives are commonly used to modify the properties of the mixed aqueous dispersion and are obvious to a person skilled in the art, any additives can be used

The mixed aqueous dispersion of polyimide-fluororesin-polar crystal fine particles may optionally contain a coloring agent such as carbon black. It is important to keep the pH of this mixed aqueous dispersion in the neutral range of 7.0 to 8.0. If the pH of the mixed aqueous dispersion is on the acidic side (e.g., pH 6.0), heat shock may occur when the coating film is formed, causing cracking and solids to form in the film.

The following is a description of a preparation method of a mixed aqueous dispersion of a polyimide precursor or polyimide-fluororesin-polar crystal fine particles.

This preparation method of the mixed aqueous dispersion comprises: pulverizing and sieving polar crystal particles to obtain polar crystal fine particles with a particle size of 3 μm or less;
preparing dispersion 1 containing the polar crystal fine particles;
preparing dispersion 2 containing a polyimide precursor or polyimide;
preparing dispersion 3 containing fluororesin; and
mixing all of the above dispersions 1, 2 and 3.

This preparation method may further comprise:
adding potassium persulfate to water to prepare a potassium persulfate aqueous solution;
preparing dispersion 4 containing alumina; and
mixing all of said dispersions and the potassium persulfate aqueous solution.

In another aspect, this preparation method of the mixed aqueous dispersion comprises:
adding potassium persulfate to water to prepare a potassium persulfate aqueous solution; and
mixing polyimide, fluororesin, polar crystal fine particles, alumina, and the above potassium persulfate aqueous solution.

Further, the preparation method of the mixed aqueous dispersion may also comprise, as a pre-treatment, mixing polyimide with ethanol phosphoric acid solution followed by drying to prepare a polyimide-phosphoric acid mixed powder.

In these steps, the mixing method, mixing temperature, and mixing time are not particularly limited, and any conventionally used mixing method that can produce a mixed aqueous dispersion can be used.

The potassium persulfate aqueous solution is prepared by adding solid potassium persulfate to water.

Specifically, potassium persulfate is added to water to make the amount of potassium persulfate 1 wt. %, followed by heating the water to the point where it does not boil to dissolve the potassium persulfate, thereby preparing the potassium persulfate aqueous solution.

Polyimide may be slightly soluble in aqueous solvent. Thus, in order to improve the aqueous dispersibility of the polyimide, the polyimide can be pre-treated before preparing the mixed aqueous dispersion.

The pre-treating step comprises mixing polyimide with ethanol phosphoric acid solution and then drying the mixed solution to evaporate moisture, thereby producing a polyimide-phosphoric acid mixed powder.

The use of the polyimide-phosphoric acid mixed powder can provide greatly improved the aqueous dispersibility of polyimide compared to the use of polyimide alone, which can readily produce the mixed aqueous dispersion according to the present invention.

Needless to say, the mixed aqueous dispersion of the present invention can be produced even if the pre-treating step is not performed.

The prepared mixed aqueous dispersion can be made into a polyimide-fluororesin mixed powder by evaporating moisture.

The polyimide-fluororesin mixed powder can be used as an excellent molding material which can be used for a wide range of products, such as high heat-resistant products, because the polyimide-fluororesin mixed powder has polyimide and fluororesin uniformly mixed, and contains alumina and potassium persulfate which provide excellent adhesive properties and heat resistance properties.

The polyimide-fluororesin mixed powder is produced by drying the mixed aqueous dispersion of polyimide-fluororesin-polar crystal fine particles according to the present invention, and evaporating moisture.

The drying method for producing the polyimide-fluororesin mixed powder is not especially limited, and any method may be used that can evaporate moisture in the mixed aqueous dispersion of polyimide-fluororesin-polar crystal fine particles to obtain powder.

The coating method using the mixed aqueous dispersion of a polyimide precursor or polyimide-fluororesin-polar crystal fine particles of the present invention comprises applying the above mixed aqueous dispersion of a polyimide precursor or polyimide- fluororesin-polar crystal fine particles on the surface to be coated, and heat treating it to 350 to 400° C.

Although the heat treating, also referred to as sintering, is a process required for producing the coating of the present invention, the method of heat treating is not especially limited, and common heating equipment used in the field can be used.

### Embodiment 2

Similar to the heat dissipating laminate of the above Embodiment 1, the heat dissipating laminate of the present embodiment also has a configuration which comprises a first layer (1, 2, 3) consisting of mixed graphite (1, 2, 3); a first sheet body (4) laminated to the bottom surface that is one surface of the first layer (1, 2, 3); and a second sheet body (5) laminated to the top surface that is another surface of the first layer (1, 2, 3), wherein a coating (6) is applied on the second sheet body. The first layer (1, 2, 3) (mixed graphite layer) can include graphite foam (1, 2) and a filler (3), and the first sheet body (4) can be a polyester sheet or aluminum foil.

The present invention can have a configuration in which the graphite foam consists of a first graphite foam (1) with a smaller particle size and a second graphite foam (2) with a larger particle size.

The filler (3) can be one or more thermally conductive fillers selected from the group consisting of artificial graphite, boron nitride, and milled pitch-based carbon fibers; the graphite foam (1, 2) can have the first graphite foam (1) of 30 to 45 wt. % and the second graphite foam (2) of 50 to 65 wt. %; the graphite foam (1, 2) constitutes 80 to 95 wt. % of the whole mixed graphite layer (1, 2, 3); and the mixed graphite layer has a density of 0.8 to 1.5 g/cm³.

A feature specific to this embodiment is that the present invention has a configuration in which a graphite film (8) is laminated on the lower surface of the first sheet body (4) via an adhesive layer (7).

As a graphite film, a product obtained by sintering a polyimide film can be employed.

The adhesive layer (7) in this embodiment preferably has a configuration consisting of one or more metal oxide sols selected from the group consisting of metal oxide sols of tin oxide, titanium oxide, tantalum oxide, niobium oxide and zirconium oxide; one or more compounds selected from the group consisting of potassium persulfate, acetic acid, benzoic acid, phenyl phosphonic acid and benzoyl; and PVA resin.

Therefore, the present invention can provide a heat dissipating laminate that exhibits excellent thermal conductivity not only in the plane direction (XY-axis), but also in the thickness direction (Z-axis direction).

### EXAMPLE

The heat dissipating laminate of the present invention will be described in detail based on the following example. However, the present invention is not limited to the example.

### Example 1

A heat dissipating laminate according to the example corresponding to the first aspect of the present invention was produced (see (a) in FIG. 1). 40 wt. % of a first graphite foam (1) with a particle size of 30 to 50 μm and 60 wt. % of a second graphite foam (2) with a particle size of 200 to 250 μm were combined with a filler (3) of green silicon carbide. The combination ratio between the first and second graphite foams (1, 2) and artificial graphite filler (3) was 80 wt. % to 20 wt. %, respectively, so that a mixed graphite was obtained. Then, 0.02 mm aluminum foils (4, 5), which had been previously treated with an adhesive, were placed, the formed mixed graphite (1, 2, 3) was put on top, and additional aluminum foils (4, 5) were laminated and press-molded, which produced a laminate with a thickness of 0.5 mm. Furthermore, a coating (6) was applied to the aluminum foil (5) to obtain a heat dissipating material.

The composition of coating (6) is:
polyimide dispersion (W-20, manufactured by Nakada Coating Co., Ltd.) of 30 wt. %;
PTFE dispersion (PTFE-D, manufactured by Daikin Industries, Ltd.) of 70 wt. %;
alumina sol (Al-L7, manufactured by Taki Chemical Co., Ltd.) of 5 wt. %;
potassium persulfate of 1 wt. %; and
pink tourmaline dispersion: the pink tourmaline with a particle size of 3 μm or less (from Sri Lanka) was prepared as 30%, 10%, or 5% dispersion.

The coating (6) was prepared as follows:

Step 1. Pink tourmaline powder was pulverized according to the standard method, and filtered through a 3-μm sieve to sort fine particles with a particle size of 3 μm or less, followed by the addition of water to obtain 5% suspension.

Step 2. Potassium persulfate was added to pure water so that potassium persulfate is 1 wt. %, heated to 95° C. and dissolved to prepare a potassium persulfate aqueous solution.

Step 3. Polyimide dispersion, PTFE dispersion, alumina sol, potassium persulfate aqueous solution, and pink tourmaline dispersion were mixed to produce the example (mixed aqueous dispersion of polyimide-fluoropolymer-polar crystal fine particles). In this case, the pH was confirmed to be between 7.0 and 8.0.

The radiation coefficient was %, the thermal conductivity in the plane direction (xy-axis direction) was W/m·K, and the thermal conductivity in the thickness direction (z-axis direction) W/m·K.

### (Comparative Example 1)

40 wt. % of a first graphite foam (1) with a particle size of 30 to 50 μm and 60 wt. % of a second graphite foam (2) with a particle size of 200 to 250 μm were combined with a filler (3) of green silicon carbide. The combination ratio between the first and second graphite foams (1, 2) and artificial graphite filler (3) was 80 wt. % to 20 wt. %, respectively, so that a mixed graphite was obtained. Then, 0.02 mm aluminum foils (4, 5), which had been previously treated with an adhesive, were placed, the formed mixed graphite (1, 2, 3) was put on top, and additional aluminum foils (4, 5) were laminated and press-molded, which produced a laminate with a thickness of 0.5 mm.

In this case, instead of the coating, a water-based paint was applied to the aluminum foil (5), thereby obtaining a heat dissipating laminate. A paint for screen printing (water-based paint) manufactured by Seiko Advance Inc. was used as the water-based paint.

The components of this paint (including binder) consist of hexane, ethylene glycol, carbon black, acrylic resin, and solvent.

The radiation coefficient was 49.2%, the thermal conductivity in the plane direction (xy-axis direction) was 218.2 W/m·K, and the thermal conductivity in the thickness direction (z-axis direction) was 5.38 W/m·K.

### INDUSTRIAL APPLICABILITY

The heat dissipating laminate of the present invention exhibits excellent heat conductivity not only in the plane direction (XY-axis direction), but also in the thickness direction (Z-axis direction), and thus, can be suitably used for cooling CPUs or memories in 5G smartphones with high speed and high capacity.

### REFERENCE NUMBERS

1 First graphite foam (first layer)
2 Second graphite foam (second layer)
3 Filler (first layer)
4, 5 Sheet body
6 Coating
7 Adhesive layer
8 Graphite film (second layer)

1. A heat dissipating laminate comprising:
a first layer consisting of one or more selected from the group consisting of expanded graphite and mixed graphite;
a first sheet body laminated to one side of the first layer; and
a second sheet body laminated to another side of the first layer, wherein a coating is applied on the second sheet body.

2. The heat dissipating laminate according claim 1,
wherein the first layer is a mixed graphite layer, the mixed graphite layer comprising graphite foam and a filler, and
the first sheet body is a polyester sheet or aluminum foil.

3. The heat dissipating laminate according to claim 1,
wherein the graphite foam consists of a first graphite foam with a smaller particle size and a second graphite foam with a larger particle size.

4. The heat dissipating laminate according to claim 3,
wherein the filler is one or more thermally conductive fillers selected from the group consisting of artificial graphite, boron nitride and milled pitch-based carbon fibers, the graphite foam has the first graphite foam of 30 to 45 wt. % and the second graphite foam of 50 to 65 wt. %,
the graphite foam constitutes 80 to 95 wt. % of the whole mixed graphite layer, and
the mixed graphite layer has a density of 0.8 to 1.5 g/cm³.

5. The heat dissipating laminate according to claim 1,
wherein the first layer is a mixed graphite layer or expanded graphite layer, and a graphite film is laminated to a lower surface of the first sheet body via an adhesive layer.

6. The heat dissipating laminate according claim 1,
wherein a layer of the coating layer comprises a composition containing a polyimide component, a fluororesin component, fine particles of polar crystals, and water.

7. The heat dissipating laminate according to claim 6,
wherein the fine particles of polar crystals are one or more fine particles selected from the group consisting of pink tourmaline and black tourmaline.

8. The heat dissipating laminate according to claim 5,
wherein the adhesive layer consists of one or more metal oxide sols selected from the group consisting of metal oxide sols of tin oxide, titanium oxide, tantalum oxide, niobium oxide and zirconium oxide; one or more compounds selected from the group consisting of potassium persulphate, acetic acid, benzoic acid, phenyl phosphonic acid and benzoyl; and PVA resin.

9. The heat dissipating laminate according to claim 4,
wherein a layer of the coating comprises a composition containing a polyimide component, a fluororesin component, fine particles of polar crystals, and water.
